(19) United States
(12) Patent Application Publication
(10) Pub. No.: US 2008/0021167 A1
(43) Pub. Date: Jan. 24, 2008

(54) SULFONATED GRAFT COPOLYMERS

(75) Inventor: Klin A. Rodrigues, Signal Mountain, TN (US)

Correspondence Address: NATIONAL STARCH AND CHEMICAL COMPANY, P.O. BOX 6500, BRIDGEWATER, NJ, 08807-3300, US

(73) Assignee: NATIONAL STARCH AND CHEMICAL INVESTMENT HOLDING CO, New Castle, DE (US)

(21) Appl. No.: 11/459,225

(22) Filed: Jul. 21, 2006

(51) Int. Cl. C08F 297/02

(52) U.S. Cl. 525/242

(57) ABSTRACT

Sulfonated graft copolymer obtained by radical graft copolymerization of one or more synthetic monomers in the presence of hydroxyl-containing naturally derived materials. The graft copolymer includes 0.1 to 100 wt %, based on weight of the total synthetic monomers, of at least one monoethylenically unsaturated monomer having a sulfonic acid group, monoethylenically unsaturated sulfuric acid ester or salt thereof, with the monomer and hydroxyl-containing naturally derived materials present in a weight ratio of 5:95 to 95:5.

### BACKGROUND OF THE INVENTION

1. Technical Field

The present invention relates to graft copolymers formed from both synthetic and naturally derived materials. More particularly, the present invention is directed towards sulfonated graft copolymers formed from synthetic sulfonate moieties grafted onto saccharides and polysaccharides.

2. Background Information

Graft copolymers produced by grafting sulfonate groups onto sugars such as mono- and disaccharides are known in the art. According to one technique, these polymers are made using mercaptan chain transfer agents. However, the mercaptans tend to stop growing chains and start new chains, producing ungrafted synthetic homopolymers. Performance from these materials is mainly due to the synthetic homopolymers, as exemplified by the relatively low amounts of saccharides (40 wt % or less). Higher amounts of sugar result in phase separation. Secondly, the functionality of these materials (e.g., calcium binding) tends to be inversely proportional to the amount of saccharide constituent (i.e., the greater the weight percent of saccharide, the lower the functionality). This characteristic indicates that the material is mostly synthetic copolymer and saccharide, with little to no grafting. Therefore, the saccharide contribution to properties such as calcium binding is, at best, negligible. When higher molecular weight polysaccharides such as maltodextrins have been used, precipitants form indicating that there is little or no grafting, with the resultant synthetic polymer phase separating from the polysaccharide.

Therefore, there is a need for sulfonated graft copolymers with low levels of synthetic homopolymers. By reducing the level of synthetic homopolymers, the level of unreacted sugars (which act as a diluent) is reduced. By successfully grafting onto the sugar, the natural part of the copolymer is utilized, resulting in better performance.

Additionally, there is a need for sulfonated graft copolymers with a large weight percent (greater than 50 or 60 wt %) of the saccharide component. Such copolymers provide low cost materials, minimize the amount of synthetic monomers derived from petroleum resources, improve biodegradability and provide a renewable raw material source.

### SUMMARY OF THE INVENTION

The present invention is directed towards sulfonated graft copolymers that perform as well as wholly synthetic polymers in dispersancy and scale inhibition applications in aqueous treatment systems. Additionally, the present invention is directed towards graft copolymers with a high degree of the natural component. Copolymers according to the present invention have performance properties similar to synthetic polymers (e.g., scale minimization, such as calcium phosphate scale) but cost less, are readily available, and are environmentally friendly materials derived from renewable sources. These copolymers have application in water treatment, detergent, oil field and other dispersant applications.

The present invention also provides for processes for making sulfonated graft copolymers using polysaccharides having molecular weights that are higher than mono- and disaccharides.

Accordingly, the present invention is directed towards sulfonated graft copolymer obtained by radical graft copolymerization of one or more synthetic monomers in the presence of hydroxyl-containing naturally derived materials that are (a) monosaccharides or disaccharides or (b) oligosaccharides, polysaccharides or small natural molecules. The copolymers include from about 0.1 to 100 wt %, based on total weight of the synthetic monomers, of at least one monoethylenically unsaturated monomer having a sulfonic acid group, monoethylenically unsaturated sulfuric acid ester or salt thereof. When the hydroxyl-containing naturally derived materials are monosaccharides or disaccharides, the hydroxyl-containing naturally derived materials are present in an amount of at least 60% by weight based on total weight of the copolymer. When the hydroxyl-containing naturally derived materials are oligosaccharides, polysaccharides or small natural molecules, the hydroxyl-containing naturally derived materials are present in an amount of at least about 5% by weight based on total weight of the copolymer.

In one aspect, the sulfonated graft copolymers are such that the one or more synthetic monomers and hydroxyl-containing naturally derived materials are present in a weight ratio of about 50:50 to 10:90, respectively. In another aspect, the one or more synthetic monomers and hydroxyl-containing naturally derived materials are present in a weight ratio of about 60:40 to 95:5, respectively. In even another aspect, the one or more synthetic monomers and hydroxyl-containing naturally derived materials are present in a weight ratio of about 50:50 to about 10:90, respectively.

In one aspect, sulfonated graft copolymers according to the present invention also optionally include about 5 to 95 wt %, based on total weight of the one or more synthetic monomers, of at least one monoethylenically unsaturated C₃-C₁₀ carboxylic acid, or salt thereof.

In one aspect, sulfonated graft copolymers according to the present invention also optionally include about 0.1 to 50 wt %, based on total weight of the one or more synthetic monomers, of at least one ethylenically unsaturated C₄-C₁₀ dicarboxylic acid, or salt thereof.

In one aspect, sulfonated graft copolymers according to the present invention also optionally include one or more monomers having a nonionic, hydrophobic and/or carboxylic acid group, wherein the one or more monomers are incorporated into the copolymer in an amount of about 10 wt % or less based on total weight of the graft copolymer.

In one aspect, the hydroxyl-containing naturally derived material of the sulfonated graft copolymer is water soluble. In another aspect, the hydroxyl-containing naturally derived material of the sulfonated graft copolymer is a maltodextrin.

Examples of sulfonic acid monomer suitable for use in sulfonated graft copolymers according to the present invention include 2-acrylamido-2-methyl propane sulfonic acid, vinyl sulfonic acid, sodium (meth)allyl sulfonate, sulfonated styrene, (meth)allyloxybenzene sulfonic acid, sodium 1-allyloxy 2 hydroxy propyl sulfonate and combinations thereof. In another aspect, the sulfonic acid monomer is 2-acrylamido-2-methyl propane sulfonic acid or sodium (meth)allyl sulfonate. In even another aspect, the sulfonic acid monomer is 2-acrylamido-2-methyl propane sulfonic acid.

The weight percent of the natural component in sulfonated graft copolymer according to the present invention can be about 20 wt % or greater.

Sulfonated graft copolymers according to the present invention are suitable for use in cleaning compositions. Such cleaning compositions can include one or more adjuvants. In one aspect, the copolymer is present in the cleaning composition in an amount of from about 0.01 to about 10 weight %. In one aspect, the cleaning composition is a detergent composition. The detergent composition can be a powdered detergent composition or an autodish composition. Detergent compositions include zero phosphate detergent compositions.

The present invention provides a method of reducing spotting and/or filming in the rinse cycle of an automatic dishwasher by adding to the rinse cycle a rinse aid composition comprising the sulfonated graft copolymer according to the invention. The present invention also provides for a method of improving sequestration, threshold inhibition and soil removal in a cleaning composition by adding the sulfonated graft copolymer according to the invention to the cleaning composition.

In one embodiment, the present invention is directed towards water treatment systems comprising sulfonated graft copolymers according to the present invention, wherein the graft copolymer is present in the system in an amount of at least about 0.5 mg/L.

In one embodiment, the present invention provides a method of dispersing and/or minimizing scale in a water treatment or oilfield system by adding the sulfonated graft copolymer according to the present invention to the water treatment or oilfield system. In another embodiment, the present invention provides a method of dispersing pigments and/or minerals in a solution by adding the sulfonated graft copolymer according to the present invention to a dispersant composition. Minerals that can be dispersed include, for example, titanium dioxide, kaolin clays, modified kaolin clays, calcium carbonates and synthetic calcium carbonates, iron oxides, carbon black, talc, mica, silica, silicates, and aluminum oxide. The present invention also provides a method of dispersing soils and dirt in cleaning and water treatment applications by adding a dispersant composition comprising the sulfonated graft copolymer according to the present invention to cleaning system or water treatment system.

Dispersant composition according to the present invention can be added to, for example, paints, coatings, plastics, rubbers, filtration products, cosmetics, cement and concrete and/or food and/or paper coatings.

The present invention is further directed towards fiberglass binders comprising sulfonated graft copolymers according to the present invention, wherein the graft copolymer is present in the system from about 0.1 to 50 weight percent of the binder.

The present invention also provides for a method of reducing scale in oilfields by adding the sulfonated graft copolymer according to the present invention to an oilfield treatment composition, wherein the oilfield treatment composition is used in cementing and drilling mud applications.

### DETAILED DESCRIPTION OF THE INVENTION

Sulfonated graft copolymers according to the present invention are produced by grafting synthetic sulfonated monomers onto hydroxyl-containing naturally derived materials. Use of natural materials to produce a sulfonated graft copolymer is an attractive and readily available substitute for current synthetic materials. Such substitute natural materials include, for example, organic acids and small molecule natural alcohols like glycerol, which are by-products of biodiesel production. Glycerol is also a by-product of oils and fats used in the manufacture of soaps and fatty acids, and can be produced by fermentation of sugar. In one aspect of the present invention, the small molecule natural alcohol is glycerol. Organic acids include, for example, citric acid, which is produced industrially by mold fermentation of carbohydrates from lemon, lime, pineapple juice, molasses, etc. Another organic acid, lactic acid, is produced commercially by fermentation of milk whey, starch, potatoes, molasses, etc. Tartaric acid is one naturally occurring byproduct of the wine making process.

As noted above, these hydroxyl-containing naturally derived materials include small molecule natural alcohols such as glycerol, citric acid, lactic acid, tartaric acid, gluconic acid, glucoheptonic acid, monosaccharides and disaccharides such as sugars. In another aspect, they include larger molecules such as oligosaccharides and polysaccharides (e.g., maltodextrins and starches). Examples of these monosaccharides and disaccharides include sucrose, fructose, maltose, glucose, saccharose and others. For the purpose of the present invention, oligosaccharides are defined as having an average of 3 to about 10 anhydroglucose repeat units per molecule. In like manner, polysaccharides, for the purpose of the present invention, are defined as having more than about 10 anhydroglucose repeat units per molecule.

In one aspect the natural component of the sulfonated graft copolymer is glycerol, citric acid, maltodextrins, sucrose and maltose. In a further aspect, maltodextrins are used as the polysaccharide and sucrose and maltose are used as the monosaccharides.

Polysaccharides useful in the present invention can be derived from plant, animal and microbial sources. Examples of such polysaccharide sources include starch, cellulose, gums (e.g., gum arabic, guar and xanthan), alginates, pectin and gellan. Starches include those derived from maize and conventional hybrids of maize, such as waxy maize and high amylose (i.e., greater than 40% amylose) maize, as well as other starches such as potato, tapioca, wheat, rice, pea, sago, oat, barley, rye, and amaranth, including conventional hybrids or genetically engineered materials. Also included are hemicellulose or plant cell wall polysaccharides such as D-xylans. Examples of plant cell wall polysaccharides include arabino-xylans such as corn fiber gum, a component of corn fiber.

Useful polysaccharides should be water soluble during the grafting. This implies that the polysaccharides either have a molecular weight low enough to be water soluble or can be hydrolyzed in situ during the reaction to become water soluble. For example, non-degraded starches are not water soluble. However, degraded starches are water soluble and can be used.

Hydroxyl-containing natural materials (monosaccharides, oligosaccharides and polysaccharides) can be degraded oxidatively, hydrolytically or enzymatically. Generally speaking, degraded polysaccharides according to the present invention can have a number average molecular weight (Mn) of about 100,000 or less. In one aspect, the number average molecular weight of the sulfonated graft copolymer is about 25,000 or less. In another aspect, the degraded polysaccharides have a number average molecular weight of about 10,000 or less.

These monosaccharides, oligosaccharides and polysaccharides can optionally be chemically modified. Chemically modified derivatives include carboxylates, sulfonates, phosphates, phosphonates, aldehydes, silanes, alkyl glycosides, alkyl-hydroxyalkyls, carboxy-alkyl ethers and other derivatives. The polysaccharide can be chemically modified before, during or after the grafting reaction.

Oligosaccharides useful in the present invention include corn syrups. Corn syrups are defined as degraded starch products having a DE of 27 to 95. Examples of specialty corn syrups include high fructose corn syrup and high maltose corn syrup. Monosaccharides and disaccharides such as galactose, mannose, sucrose, maltose, ribose, trehalose and lactose can also be used.

Other polysaccharides useful in this invention include maltodextrins, which are polymers having D-glucose units linked primarily by α-1,4 bonds and a dextrose equivalent (‘DE’) of less than about 20. Dextrose equivalent is a measure of the extent of starch hydrolysis. It is determined by measuring the amount of reducing sugars in a sample relative to dextrose (glucose). The DE of dextrose is 100, representing 100% hydrolysis. The DE value gives the extent of hydrolysis (e.g., 10 DE is more hydrolyzed than 5 DE maltodextrin). Maltodextrins are available as a white powder or concentrated solution and are prepared by the partial hydrolysis of starch with acid and/or enzymes. Maltodextrins typically have a distribution of chain lengths, depending upon the number of anhydrous glucose repeat units. The number of repeat units can vary from 1 to greater than 10. (For example, a DE of about 20 would have approximately 5 repeat units, a DE of 100 is equivalent to about 1 repeat unit, and a DE of 1 is equivalent to about 100 repeat units.) In maltodextrins, the larger weight fraction of a sample has greater than 10 anhydroglucose repeat units. Therefore, by convention maltodextrins are considered to be a polysaccharide, even though they may have components that fall under the oligosaccharide definition.

Polysaccharides useful in the present invention further include pyrodextrins. Pyrodextrins are made by heating acidified, commercially dry starch to a high temperature. Extensive degradation occurs initially due to the usual moisture present in starch. However, unlike the above reactions that are done in aqueous solution, pyrodextrins are formed by heating powders. As moisture is driven off by the heating, hydrolysis stops and recombination of hydrolyzed starch fragments occur. This recombination reaction makes these materials distinct from maltodextrins, which are hydrolyzed starch fragments. The resulting pyrodextrin product also has much lower reducing sugar content, as well as color and a distinct odor.

Polysaccharides can be modified or derivatized by etherification (e.g., via treatment with propylene oxide, ethylene oxide, 2,3-epoxypropyl trimethyl ammonium chloride), esterification (e.g., via reaction with acetic anhydride, octenyl succinic anhydride (‘OSA’)), acid hydrolysis, dextrinization, oxidation or enzyme treatment (e.g., starch modified with α-amylase, β-amylase, pullanase, isoamylase or glucoamylase), or various combinations of these treatments. These treatments can be performed before or after the graft copolymerization process.

The natural component can range in weight from 10 to 90 weight percent of the total weight of the copolymer. In one embodiment, the natural component ranges from 20 to 70 percent by weight of total weight of copolymer. In another embodiment, the natural component ranges from 20 to 50 percent by weight of total weight of copolymer.

Any polymerizable monomer which contains a sulfonate group can be used to produce sulfonated graft copolymers according to the present invention. Sulfonated monomers include but are not limited to 2-acrylamido-2-methyl propane sulfonic acid (‘AMPS’), vinyl sulfonic acid, sodium (meth)allyl sulfonate, sulfonated styrene, (meth)allyloxybenzene sulfonic acid, sodium 1-allyloxy 2 hydroxy propyl sulfonate, and combinations thereof.

The sulfonated monomer can be from about 2 up to 100 percent by weight of the total synthetic monomer weight of the copolymer. In one embodiment, the sulfonated monomer is about 5 to 95 percent by weight of the total synthetic monomer weight of the copolymer. In another embodiment, the sulfonated monomer is about 5 to 50 percent by weight of the total synthetic monomer weight of the copolymer. In even another embodiment, the sulfonated monomer is about 10 to about 25 percent by weight of the total synthetic monomer weight of the copolymer.

Other polymerizable monomers can be added in addition to the sulfonated monomer when producing the sulfonated graft copolymers of this invention. These optional monomers can include, for example, monomers with a non-ionic, hydrophobic or carboxylic acid group. Monomers with a carboxylic acid group are preferred for economic reasons.

Optional carboxylic acid monomers include, for example, monoethylenically unsaturated C₃-C₁₀ carboxylic acids. Examples of such carboxylic acid monomers include but are not limited to acrylic acid, methacrylic acid, ethacrylic acid, α-chloro-acrylic acid, α-cyano acrylic acid, β-methyl-acrylic acid (crotonic acid), α-phenyl acrylic acid, β-acryloxy propionic acid, sorbic acid, α-chloro sorbic acid, angelic acid, cinnamic acid, p-chloro cinnamic acid, β-styryl acrylic acid (1-carboxy-4-phenyl butadiene-1,3), and others. The alkali, alkaline earth metal or ammonium salts of these acids can also be used. In one embodiment, monoethylenically unsaturated C₃-C₁₀ carboxylic acids comprise from about 5 to 95 weight % of the total weight percent of the synthetic monomer constituency of the graft copolymer.

Optional carboxylic acid monomers also include monoethylenically unsaturated C₄-C₁₀ dicarboxylic acids, the alkali or alkaline earth metal or ammonium salts thereof, and the anhydrides thereof. Examples of such carboxylic acid monomers include but are not limited to itaconic acid, maleic acid, citraconic acid, mesaconic acid, glutaconic acid, aconitic acid, fumaric acid, tricarboxy ethylene, and others. Moieties such as maleic anhydride or acrylamide that can be derivatized to an acid-containing group can also be used. The alkali, alkaline earth metal or ammonium salts of these acids can also be used. In one embodiment, monoethylenically unsaturated C₄-C₁₀ dicarboxylic acids comprise up to about 40 weight % of the total weight percent of the synthetic monomer constituency of the graft copolymer.

In one aspect the carboxylic acid monomer is acrylic acid, methacrylic acid, or mixtures thereof. In another aspect the carboxylic acid monomer is acrylic acid.

Examples of optional hydrophobic monomers include saturated or unsaturated alkyl, hydroxyalkyl, alkylalkoxy groups, arylalkoxy, alkarylalkoxy, aryl and aryl-alkyl groups, siloxane and combinations thereof. Examples of hydrophobic monomers also include styrene, α-methyl styrene, methyl methacrylate, methyl acrylate, 2-ethylhexyl acrylate, octyl acrylate, lauryl acrylate, stearyl acrylate, behenyl acrylate, 2-ethylhexyl methacrylate, octyl methacrylate, lauryl methacrylate, stearyl methacrylate, behenyl methacrylate, 2-ethylhexyl acrylamide, octyl acrylamide, lauryl acrylamide, stearyl acrylamide, behenyl acrylamide, propyl acrylate, butyl acrylate, pentyl acrylate, hexyl acrylate, 1-vinyl naphthalene, 2-vinyl naphthalene, 3-methyl styrene, 4-propyl styrene, t-butyl styrene, 4-cyclohexyl styrene, 4-dodecyl styrene, 2-ethyl-4-benzyl styrene, and 4-(phenyl butyl) styrene. Combinations of hydrophobic monomers can also be used.

Examples of optional non-ionic monomers include C₁-C₆ alkyl esters of (meth)acrylic acid and the alkali or alkaline earth metal or ammonium salts thereof, acrylamide and the C₁-C₆ alkyl-substituted acrylamides, the N-alkyl-substituted acrylamides and the N-alkanol-substituted acrylamides, hydroxyl alkyl acrylates and acrylamides. Also useful are the C₁-C₆ alkyl esters and C₁-C₆ alkyl half-esters of unsaturated vinylic acids, such as maleic acid and itaconic acid, and C₁-C₆ alkyl esters of saturated aliphatic monocarboxylic acids, such as acetic acid, propionic acid and valeric acid. In one aspect the nonionic monomers are selected from the group consisting of methyl methacrylate, methyl acrylate, hydroxyethyl (meth)acrylate and hydroxypropyl (meth)acrylate.

### Process for Producing Sulfonated Graft Copolymers—

The present invention provides a process for making sulfonated graft copolymers. The graft copolymers are made using a redox system of a metal ion and hydrogen peroxide. In another aspect, the graft copolymers are made using free radical initiating systems such as ceric ammonium nitrate and Fe (II)/H₂O₂ (see, Würzburg, O. B., MODIFIED STARCHES: PROPERTIES AND USES, Grafted Starches, Chpt. 10, pp. 149-72, CRC Press, Boca Raton (1986)). Fe (II) can be substituted with other metal ions such as Cu (II), Co (III), Mn (III) and others. Unlike the free radical initiating systems, chain transfer agents such as mercaptans and/or amines tend to produce excessive amounts of synthetic homopolymers (if one monomer is used) or copolymers (if more than one monomer is used) and therefore are not preferred. Process reaction temperature ranges from about 40° C. to about 130° C. In another aspect, reaction temperature ranges from about 80° C. to about 100° C.

Sulfonated graft copolymers according to the present invention have been found to be excellent dispersants and scale minimizing agents in a wide variety of aqueous systems. These systems include but are not limited to water treatment, cleaning formulations, oilfield and pigment dispersion. These systems are described in further detail below. In another aspect, the sulfonated graft copolymers have been found to be excellent sizing agents for fiberglass, non-wovens and textiles.

### Cleaning Formulations—

Sulfonated graft copolymers according to the present invention can be used in a variety of cleaning formulations. Such formulations include both powdered and liquid laundry formulations such as compact and heavy duty detergents (e.g., builders, surfactants, enzymes, etc.), automatic dishwashing detergent formulations (e.g., builders, surfactants, enzymes, etc.), light-duty liquid dishwashing formulations, rinse aid formulations (e.g., acid, nonionic low foaming surfactants, carrier, etc.) and/or hard surface cleaning formulations (e.g., zwitterionic surfactants, germicide, etc.).

The sulfonated graft copolymers can be used as viscosity reducers in processing powdered detergents. They can also serve as anti-redeposition agents, dispersants, scale and deposit inhibitors, and crystal modifiers, providing whiteness maintenance in the washing process.

Any suitable adjunct ingredient in any suitable amount can be used in the cleaning formulations described herein. Useful adjunct ingredients include, for example, aesthetic agents, anti-filming agents, anti-redeposition agents, anti-spotting agents, anti-graying agents, beads, binders, bleach activators, bleach catalysts, bleach stabilizing systems, bleaching agents, brighteners, buffering agents, builders, carriers, chelants, clay, color speckles, control release agents, corrosion inhibitors, dishcare agents, disinfectant, dispersant agents, draining promoting agents, drying agents, dyes, dye transfer inhibiting agents, enzymes, enzyme stabilizing systems, fillers, free radical inhibitors, fungicides, germicides, hydrotropes, opacifiers, perfumes, pH adjusting agents, pigments, processing aids, silicates, soil release agents, suds suppressors, surfactants, stabilizers, thickeners, zeolite, and mixtures thereof.

The cleaning formulations can further include builders, enzymes, surfactants, bleaching agents, bleach modifying materials, carriers, acids, corrosion inhibitors and aesthetic agents. Suitable builders include, but are not limited to, alkali metals, ammonium and alkanol ammonium salts of polyphosphates, alkali metal silicates, alkaline earth and alkali metal carbonates, nitrilotriacetic acids, polycarboxylates, (such as citric acid, mellitic acid, succinic acid, oxydisuccinic acid, polymaleic acid, benzene 1,3,5-tricarboxylic acid, carboxymethyl oxysuccinic acid, and water-soluble salts thereof), phosphates (e.g., sodium tripolyphosphate), and mixtures thereof. Suitable enzymes include, but are not limited to, proteases, amylases, cellulases, lipases, carbohydrases, bleaching enzymes, cutinases, esterases, and wild-type enzymes. Suitable surfactants include, but are not limited to, nonionic surfactants, anionic surfactants, cationic surfactants, ampholytic surfactants, zwitterionic surfactants, and mixtures thereof. Suitable bleaching agents include, but are not limited to, common inorganic/organic chlorine bleach (e.g., sodium or potassium dichloroisocyanurate dihydrate, sodium hypochlorite, sodium hypochloride), hydrogen-peroxide releasing salt (such as, sodium perborate monohydrate (PB1), sodium perborate tetrahydrate (PB4)), sodium percarbonate, sodium peroxide, and mixtures thereof. Suitable bleach-modifying materials include but are not limited to hydrogen peroxide-source bleach activators (e.g., TAED), bleach catalysts (e.g. transition containing cobalt and manganese). Suitable carriers include, but are not limited to: water, low molecular weight organic solvents (e.g., primary alcohols, secondary alcohols, monohydric alcohols, polyols, and mixtures thereof), and mixtures thereof.

Suitable acids include, but are not limited to, acetic acid, aspartic acid, benzoic acid, boric acid, bromic acid, citric acid, formic acid, gluconic acid, glutamic acid, hydrochloric acid, lactic acid, malic acid, nitric acid, sulfamic acid, sulfuric acid, tartaric acid, and mixtures thereof. Suitable corrosion inhibitors, include, but are not limited to, soluble metal salts, insoluble metal salts, and mixtures thereof. Suitable metal salts include, but are not limited to, aluminum, zinc (e.g., hydrozincite), magnesium, calcium, lanthanum, tin, gallium, strontium, titanium, and mixtures thereof. Suitable aesthetic agents include, but are not limited to, opacifiers, dyes, pigments, color speckles, beads, brighteners, and mixtures thereof.

With the addition of suitable adjuncts, cleaning formulations described herein can be useful as automatic dishwashing detergent (‘ADD’) compositions (e.g., builders, surfactants, enzymes, etc.), light-duty liquid dishwashing compositions, laundry compositions such as, compact and heavy-duty detergents (e.g., builders, surfactants, enzymes, etc.), rinse aid compositions (e.g., acids, nonionic low-foaming surfactants, carriers, etc.), and/or hard surface cleaning compositions (e.g., zwitterionic surfactants, germicides, etc.).

Suitable adjunct ingredients are disclosed in one or more of the following: U.S. Pat. Nos. 2,798,053; 2,954,347; 2,954,347; 3,308,067; 3,314,891; 3,455,839; 3,629,121; 3,723,322; 3,803,285; 3,929,107, 3,929,678; 3,933,672; 4,133,779; 4,141,841; 4,228,042; 4,239,660; 4,260,529; 4,265,779; 4,374,035; 4,379,080; 4,412,934; 4,483,779; 4,483,780; 4,536,314; 4,539,130; 4,565,647; 4,597,898; 4,606,838; 4,634,551; 4,652,392; 4,671,891; 4,681,592; 4,681,695; 4,681,704; 4,686,063; 4,702,857; 4,968,451; 5,332,528; 5,415,807; 5,435,935; 5,478,503; 5,500,154; 5,565,145; 5,670,475; 5,942,485; 5,952,278; 5,990,065; 6,004,922; 6,008,181; 6,020,303; 6,022,844; 6,069,122; 6,060,299; 6,060,443; 6,093,856; 6,130,194; 6,136,769; 6,143,707; 6,150,322; 6,153,577; 6,194,362; 6,221,825; 6,365,561; 6,372,708; 6,482,994; 6,528,477; 6,573,234; 6,589,926; 6,627,590; 6,645,925; and 6,656,900; International Publication Nos. 00/23548; 00/23549; 00/47708; 01/32816; 01/42408; 91/06637; 92/06162; 93/19038; 93/19146; 94/09099; 95/10591; 95/26393; 98/35002; 98/35003; 98/35004; 98/35005; 98/35006; 99/02663; 99/05082; 99/05084; 99/05241; 99/05242; 99/05243; 99/05244; 99/07656; 99/20726; and 99/27083; European Patent No. 130756; British Publication No. 1137741 A; Chemtech, pp. 30-33 (March 1993); J. American Chemical Soc., 115, 10083-10090 (1993); and Kirk Othmer Encyclopedia of Chemical Technology, 3rd Ed., Vol. 7, pp. 430-447 (John Wiley & Sons, Inc., 1979).

In one embodiment, cleaning formulations according to the present invention can include a suitable adjunct ingredient in an amount of from 0% to about 99.99% by weight of the formulation. In another aspect, the cleaning formulations can include from about 0.01% to about 95% by weight of the formulation of a suitable adjunct ingredient. In other various aspects, the cleaning formulations can include from about 0.01% to about 90%, or from about 0.01% to about 80%, or from about 0.01% to about 70%, or from about 0.01% to about 60%, or from about 0.01% to about 50%, or from about 0.01% to about 40%, or from about 0.01% to about 30%, or from about 0.01% to about 20%, or from about 0.01% to about 10%, or from about 0.01% to about 5%, or from about 0.01% to about 4%, or from about 0.01% to about 3%, or from about 0.01% to about 2%, or from about 0.01% to about 1%, or from about 0.01% to about 0.5%, or alternatively from about 0.01% to about 0.1%, by weight of the formulation of a suitable adjunct ingredient.

Cleaning formulations can be provided in any suitable physical form. Examples of such forms include solids, granules, powders, liquids, pastes, creams, gels, liquid gels, and combinations thereof. Cleaning formulations used herein include unitized doses in any of a variety of forms, such as tablets, multi-phase tablets, gel packs, capsules, multi-compartment capsules, water-soluble pouches or multi-compartment pouches. Cleaning formulations can be dispensed from any suitable device. Suitable devices include, but are not limited to, wipes, hand mittens, boxes, baskets, bottles (e.g., pourable bottles, pump assisted bottles, squeeze bottles), multi-compartment bottles, jars, paste dispensers, and combinations thereof.

In the case of additive or multi-component products contained in single- and/or multi-compartment pouches, capsules, or bottles, it is not required that the adjunct ingredients or cleaning formulations be in the same physical form. In one non-limiting embodiment, cleaning formulations can be provided in a multi-compartment, water-soluble pouch comprising both solid and liquid or gel components in unit dose form. The use of different forms can allow for controlled release (e.g., delayed, sustained, triggered or slow release) of the cleaning formulation during treatment of a surface (e.g., during one or more wash and/or rinse cycles in an automatic dishwashing machine).

The pH of these formulations can range from 1 to 14 when the formulation is diluted to a 1% solution. Most formulations are neutral or basic, meaning in the pH range of 7 to about 13.5. However, certain formulations can be acidic, meaning a pH range from 1 to about 6.5.

Copolymers according to the present invention can also be used in a wide variety of cleaning formulations containing phosphate-based builders. These formulations can be in the form of a powder, liquid or unit doses such as tablets or capsules, and can be used to clean a variety of substrates such as clothes, dishes, and hard surfaces such as bathroom and kitchen surfaces. The formulations can also be used to clean surfaces in industrial and institutional cleaning applications.

In cleaning formulations, the polymer can be diluted in the wash liquor to end use level. The polymers are typically dosed at 0.01 to 1000 ppm in the aqueous wash solutions.

Optional components in detergent formulations include, but are not limited to, ion exchangers, alkalies, anticorrosion materials, anti-redeposition materials, optical brighteners, fragrances, dyes, fillers, chelating agents, enzymes, fabric whiteners and brighteners, sudsing control agents, solvents, hydrotropes, bleaching agents, bleach precursors, buffering agents, soil removal agents, soil release agents, fabric softening agent and opacifiers. These optional components can comprise up to about 90% by weight of the detergent formulation.

Graft copolymers according to the present invention can be incorporated into hand dish, autodish and hard surface cleaning formulations. The polymers can also be incorporated into rinse aid formulations used in autodish formulations. Autodish formulations can contain builders such as phosphates and carbonates, bleaches and bleach activators, and silicates. These polymers can also be used in reduced phosphate formulations (i.e., less than 1500 ppm in the wash) and zero phosphate autodish formulations. In zero-phosphate autodish formulations, removal of the phosphates negatively affects cleaning, as phosphates provide sequestration and calcium carbonate inhibition. Graft copolymers according to the present invention aid in sequestration and threshold inhibition, as well as soil removal and therefore are suitable for use in zero-phosphate autodish formulations. Further, graft copolymers according to the present invention are useful in minimizing spotting and filming in rinse aid compositions for automatic dishwasher applications.

The above formulations can also include other ingredients such as enzymes, buffers, perfumes, anti-foam agents, processing aids, and so forth. Hard surface cleaning formulations can contain other adjunct ingredients and carriers. Examples of adjunct ingredients include, without limitation, buffers, builders, chelants, filler salts, dispersants, enzymes, enzyme boosters, perfumes, thickeners, clays, solvents, surfactants and mixtures thereof.

One skilled in the art will recognize that the amount of polymer(s) required depends upon the cleaning formulation and the benefit they provide to the formulation. In one aspect, use levels can be about 0.01 weight % to about 10 weight % of the cleaning formulation. In another embodiment, use levels can range from about 0.1 weight % to about 2 weight % of the cleaning formulation.

### Water Treatment Systems—

A common problem in industrial water treatment is water-borne deposits, commonly known as foulants. Foulants are loose, porous, insoluble materials suspended in water. They can include such diverse substances as particulate matter scrubbed from the air, migrated corrosion products, silt, clays and sand suspended in the makeup water, organic contaminants (oils), biological matter, and extraneous materials such as leaves, twigs and wood fibers from cooling towers. Fouling can reduce heat transfer by interfering with the flow of cooling water. Additionally, fouling can reduce heat transfer efficiency by plugging heat exchangers. Sulfonated graft copolymers according to the present invention are excellent dispersants for foulants, and can minimize their deleterious effects in water treatment applications.

Water treatment includes prevention of calcium scale due to precipitation of calcium salts such as calcium carbonate, calcium sulfate and calcium phosphate. These salts are inversely soluble, meaning that their solubility decreases as the temperature increases. For industrial applications where higher temperatures and higher concentrations of salts are present, this usually translates to precipitation occurring at the heat transfer surfaces. The precipitating salts can then deposit onto the surface, resulting in a layer of calcium scale. Calcium scale can lead to heat transfer loss in the system and cause overheating of production processes. This scaling can also promote localized corrosion.

Calcium phosphate, unlike calcium carbonate, is generally not a naturally occurring problem. However, orthophosphates are commonly added to industrial systems (and sometimes to municipal water systems) as a corrosion inhibitor for ferrous metals, typically at levels between 2.0-20.0 mg/L. Therefore, calcium phosphate precipitation can not only result in those scaling problems previously discussed, but can also result in severe corrosion problems as the orthophosphate is removed from solution. As a consequence, industrial cooling systems require periodic maintenance wherein the system must be shut down, cleaned and the water replaced. Lengthening the time between maintenance shutdowns saves costs and is desirable.

One way to lengthen the time between maintenance in a water treatment system is to use polymers that function in either inhibiting formation of calcium salts or in modifying crystal growth. Crystal growth modifying polymers alter the crystal morphology from regular structures (e.g., cubic) to irregular structures such as needlelike or florets. Because of the change in form, crystals that are deposited are easily removed from the surface simply by mechanical agitation resulting from water flowing past the surface. Sulfonated graft copolymers according to the present invention are particularly useful at inhibiting calcium phosphate based scale formation such as calcium orthophosphate. Further, these inventive copolymers also modify crystal growth of calcium carbonate scale.

It is also advantageous to reuse the water in industrial water treatment systems as much as possible, thereby increasing the time between maintenance. Still, water can be lost over time due to various mechanisms such as evaporation and/or spillage. As a consequence, dissolved and suspended solids tend to become more concentrated over time. Cycles of concentration refers to the number of times solids in a particular volume of water are concentrated. The quality of the water makeup determines how many cycles of concentration can be tolerated. In cooling tower applications where water makeup is hard (i.e., poor quality), 2 to 4 cycles would be considered normal, while 5 and above would represent stressed conditions. Sulfonated graft copolymers according to the present invention have been found to be effective under stressed conditions.

Copolymers according to the present invention can be added to the aqueous systems neat, or they can be formulated into various water treatment compositions and then added to the aqueous systems. In certain aqueous systems where large volumes of water are continuously treated to maintain low levels of deposited matter, the copolymers can be used at levels as low as 0.5 mg/L. The upper limit on the amount of copolymer used depends upon the particular aqueous system treated. For example, when used to disperse particulate matter, the copolymer can be used at levels ranging from about 0.5 to about 2,000 mg/L. When used to inhibit formation or deposition of mineral scale, the copolymer can be used at levels ranging from about 0.5 to about 100 mg/L. In another embodiment the copolymer can be used at levels from about 3 to about 20 mg/L, and in another embodiment from about 5 to about 10 mg/L.

Once prepared, the sulfonated graft copolymers can be incorporated into an aqueous treatment composition that includes the graft copolymer and other aqueous treatment chemicals. These other chemicals can include, for example, corrosion inhibitors such as orthophosphates, zinc compounds and tolyltriazole. The amount of inventive copolymer utilized in water treatment compositions can vary based upon the treatment level desired for the particular aqueous system treated. Water treatment compositions generally contain from about 0.001 to about 25% by weight of the sulfonated graft copolymer. In another aspect, the copolymer is present in an amount of about 0.5% to about 5% by weight of the aqueous treatment composition.

Sulfonated graft copolymers according to the present invention can be used in any aqueous system wherein stabilization of mineral salts is important, such as in heat transfer devices, boilers, secondary oil recovery wells, automatic dishwashers, and substrates that are washed with hard water. These graft copolymers can stabilize many minerals found in water, including, but not limited to, iron, zinc, phosphonate, and manganese. These copolymers also disperse particulates found in aqueous systems.

Sulfonated graft copolymers according to the present invention can be used to inhibit scales, stabilize minerals and disperse particulates in many types of processes. Examples of such processes include sugar mill anti-scalant, soil conditioning, treatment of water for use in industrial processes such as mining, oilfields, pulp and paper production, and other similar processes, waste water treatment, ground water remediation, water purification by processes such as reverse osmosis and desalination, air-washer systems, corrosion inhibition, boiler water treatment, as a biodispersant, and chemical cleaning of scale and corrosion deposits. One skilled in the art can conceive of many other similar applications for which the sulfonated graft copolymer could be useful.

### Oilfield Scale Application—

Scale formation is a major problem in oilfield applications. Subterranean oil recovery operations can involve the injection of an aqueous solution into the oil formation to help move the oil through the formation and to maintain the pressure in the reservoir as fluids are being removed. The injected water, either surface water (lake or river) or seawater (for operations offshore) can contain soluble salts such as sulfates and carbonates. These salts tend to be incompatible with ions already present in the oil-containing reservoir (formation water). The formation water can contain high concentrations of certain ions that are encountered at much lower levels in normal surface water, such as strontium, barium, zinc and calcium. As conditions affecting solubility, such as temperature and pressure, change within the producing well bores and topsides, partially soluble inorganic salts such as barium sulfate and calcium carbonate often precipitate from the production water. This is especially prevalent when incompatible waters are encountered such as formation water, seawater, or produced water.

Barium sulfate or other inorganic supersaturated salts such as strontium sulfate can precipitate onto the formation forming scale, thereby clogging the formation and restricting the recovery of oil from the reservoir. These salts can form very hard, insoluble scales that are difficult to prevent. The insoluble salts can also precipitate onto production tubing surfaces and associated extraction equipment, limiting productivity, production efficiency and compromising safety. Certain oil-containing formation waters are known to contain high barium concentrations of 400 ppm and higher. Since barium sulfate forms a particularly insoluble salt, the solubility of which declines rapidly with increasing temperature, it is difficult to inhibit scale formation and to prevent plugging of the oil formation and topside processes and safety equipment.

Dissolution of sulfate scales is difficult, requiring high pH, long contact times, heat and circulation, and therefore is typically performed topside. Alternatively, milling and, in some cases, high-pressure water washing can be used. These are expensive, invasive procedures and require process shutdown. Use of sulfonated graft copolymers according to the present invention can minimize these sulfate scales, especially downhole.

The polymers of this invention can also be used in cementing and concrete applications. The polymers function as dispersants in these applications. In downhole cementing applications, these polymers will act as fluid loss additives as well as cement set retarders. These polymers can be used as a dispersant or a fluid loss additive in drilling mud applications.

### Dispersant for Particulates—

Polymers according to the present invention can be used as a dispersant for minerals in applications such as paper coatings, paints and other coating applications. These particulates are found in a variety of applications, including but not limited to, paints, coatings, plastics, rubbers, filtration products, cosmetics, cement and concrete, food and paper coatings. Examples of minerals that can be dispersed by the inventive polymers include titanium dioxide, kaolin clays, modified kaolin clays, calcium carbonates and synthetic calcium carbonates, iron oxides, carbon black, talc, mica, silica, silicates, and aluminum oxide. Typically, the more hydrophobic the mineral the better polymers according to the present invention perform in dispersing particulates.

### Fiberglass Sizing—

In yet even another application, sulfonated graft copolymers according to the present invention can be used as a binder for fiberglass. Fiberglass insulation products are generally formed by bonding glass fibers together with a synthetic polymeric binder. Fiberglass is usually sized with phenol-formaldehyde resins or polyacrylic acid based resins. The former has the disadvantage of releasing formaldehyde during end use. The polyacrylic acid resin system has become uneconomical due to rising crude oil prices. Hence, there is a need for renewal sizing materials in this industry. The sulfonated graft polymers of this invention are a good fit for this application. They can be used by themselves or in conjunction with the with the phenol formaldehyde or polyacrylic acid binder system.

The binder composition is generally applied by means of a suitable spray applicator to a fiber glass mat as it is being formed or soon after it is formed and while it is still hot. The spray applicator aids in distributing the binder solution evenly throughout the formed fiberglass mat. The polymeric binder solution tends to accumulate at the junctions where fibers cross each other, thereby holding the fibers together at these junctions. Solids are typically present in the aqueous solution in amounts of about 5 to 25 percent by weight of total solution. The binder can also be applied by other means known in the art, including, but not limited to, airless spray, air spray, padding, saturating, and roll coating.

Residual heat from the fibers volatizes water away from the binder. The resultant high-solids binder-coated fiberglass mat is allowed to expand vertically due to the resiliency of the glass fibers. The fiberglass mat is then heated to cure the binder. Typically, curing ovens operate at a temperature of from 130° C. to 325° C. However, the binder composition of the present invention can be cured at lower temperatures of from about 110° C. to about 150° C. In one aspect, the binder composition can be cured at about 120° C. The fiberglass mat is typically cured from about 5 seconds to about 15 minutes. In one aspect the fiberglass mat is cured from about 30 seconds to about 3 minutes. The cure temperature and cure time also depend on both the temperature and level of catalyst used. The fiberglass mat can then be compressed for shipping. An important property of the fiberglass mat is that it returns substantially to its full vertical height once the compression is removed. The sulfonated graft polymer based binder produces a flexible film that allows the fiberglass insulation to bounce back after a roll is unwrapped for use in walls/ceilings.

Fiberglass or other non-wovens treated with the copolymer binder composition is useful as insulation for heat or sound in the form of rolls or batts; as a reinforcing mat for roofing and flooring products, ceiling tiles, flooring tiles, as a microglass-based substrate for printed circuit boards and battery separators; for filter stock and tape stock and for reinforcements in both non-cementatious and cementatious masonry coatings.

Low molecular weight sulfonated graft copolymers are exemplified in U.S. Pat. No. 5,580,941. These copolymers are made using mercaptan and/or amine chain transfer agents. The chain transfer agents lower the molecular weight but in the process generate synthetic polymers. These mercaptans stop a growing chain Equation 1 and start a new polymer chain Equation 2, which is illustrated in the mechanism below (Odian, George, PRINCIPLES OF POLYMERIZATION, 2^{nd} Ed., Wiley-Interscience, New York, p. 226 (1981))—

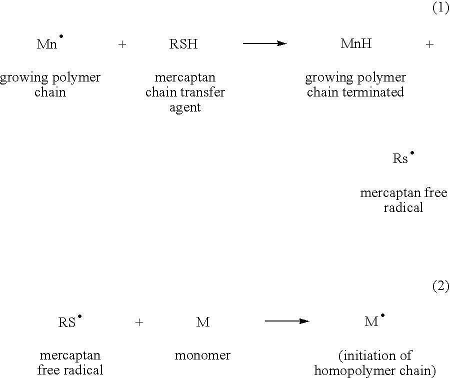

### This new chain is now comprised of ungrafted synthetic copolymers.

Additionally, the materials exemplified in this patent are synthesized using amines such as hydroxylamine chloride as part of the redox initiating system. The free radicals generated from the reaction of the amine with the hydrogen peroxide lead to homopolymer formation. This reaction competes with the grafting reaction which is the reaction of hydroxyls on the saccharide reacting with the Fe (II) and the hydrogen peroxide to form free radicals on the saccharide which leads to the formation of the graft copolymer. The combination of the amine in the initiator system and the mercaptan chain transfer agent results in a relatively high amount of homopolymer. This homopolymer especially in the neutralized form is incompatible with polysaccharides resulting in the phase separation seen in Comparative Example 1. However, if the amine initiating system and the mercaptan chain transfer agent are not employed, stable aqueous solutions are obtained even with polysaccharides (Example 1).

The performance of these materials is mainly due to the ungrafted synthetic copolymers generated in this process. This is the reason they exemplify relatively low amounts of saccharide (40 wt % or less). Higher amounts of the saccharide will phase separate. Secondly, the calcium binding data in Table 4 (Column 14) is inversely proportional to the amount of saccharide functionality. This indicates that the material is mostly a mixture of synthetic copolymer and saccharide with little to no grafting. Saccharide contribution to calcium binding is negligible.

TABLE 1

| Polymer of | Ca binding from Table 4 of ‘941 patent | wt % saccharide |
|---|---|---|
| ‘941 patent | mg CaCO₃/g polymer | in polymer |
| 1 | 1898 | 30 |
| 2 | 990 | 40 |
| 12 | >3000 | 9.7 |

Finally, Comparative Examples 3 and 5 at columns 11 and 12 of the '941 patent forms a precipitate when higher molecular weight saccharide is used (here, maltodextrins with DE 14 and 20). This illustrates that there is little grafting and the resulting synthetic polymer is phase separating from the maltodextrin. This does not happen with the other Examples because they use disaccharides such as glucose, which are small molecules and are compatible.

In contrast, polymers according to the present invention are made with polysaccharides with molecular weights greater than DE 20 (see, e.g., Example 1, 3 and 5) and are compatible, indicating a high degree of grafting.

### EXAMPLES

### Example 1

Sulfonated Graft Copolymer with Maltodextrin (a Polysaccharide) (Polymerized without the Use of Mercaptan Chain Transfer Agent)

156 g of water, 49 g of maltodextrin (Cargill MD™ 01918 maltodextrin, DE 18) and 0.0039 g of ferrous ammonium sulfate hexahydrate (FAS) were heated to 98° C. in a reactor. A mixed solution of 81.6 g of acrylic acid (AA) and 129.2 g of a 50% solution of sodium 2-acrylamido-2-methyl propane sulfonate (AMPS) was added to the reactor over a period of 45 minutes. An initiator solution of 13 g of 35% strength hydrogen peroxide in 78 g of deionized water was simultaneously added to the reactor over a period of 60 minutes. The reaction product was held at 98° C. for an additional hour, neutralized by adding 27.2 g of a 50% solution of sodium hydroxide, and cooled. The final product was a clear yellow solution. The number average molecular weight of this polymer was 68,940 and a pH of 5.1.

This sample remained a clear solution with no sign of precipitation even after 6 months. However a blend of Alcosperse 545 (AA-AMPS copolymer) and Cargill MD™ 01918 maltodextrin phase separates within a day. This is similar to the phase separation seen in Comparative Example 5 of '941 when a maltodextrin of DE 20 (even though this a lower molecular weight than that used in our recipe) is used. This indicates that the '941 Comparative Example 5 has very little graft copolymer due to the presence of mercaptan, resulting in lots of synthetic copolymer.

Further, a blend of Alcosperse 545 and saccharose or sucrose is phase stable. This is due to the fact that the latter is a small molecule and is very compatible. This supports our assertion that the materials of Examples 1, 2 and 12 of '941, due to the presence of mercaptans and organic amine initiators used in their formation, are mostly synthetic copolymers blended with the saccharose. The performance of these polymers in the Table 1 above supports this assertion.

### Example 2

Example 1 was repeated with the exception that 0.39 g of FAS was used. The final product was a clear amber solution.

### Example 3

Sulfonated Graft Copolymer with Maltose at High Levels of Saccharide (85 wt %)

160 g of water, 207.8 g of Cargill Sweet Satin Maltose (80% solution) and 0.00078 grams of copper sulfate pentahydrate were heated in a reactor to 98° C. A mixed solution containing 16.4 g of AA and 25.9 grams of a 50% solution of sodium 2-acrylamido-2-methyl propane sulfonate (AMPS) was added to the reactor over a period of 45 minutes. The saccharide was 85 weight percent of the total weight of saccharide and monomer (acrylic acid+AMPS). An initiator solution comprising 13 grams of 35% hydrogen peroxide solution in 78 grams of deionized water was simultaneously added to the reactor over a period of 60 minutes. The reaction product was held at 98° C. for an additional hour. The polymer was then neutralized by adding 8 grams of a 50% solution of NaOH. The final product was a clear yellow solution. This sample has been a clear solution and shows no sign of precipitation even after 6 months.

### Example 4

Sulfonated Graft Copolymer with Maltose at High Levels of Polysaccharide (75 wt %)

180 g of water and 146 g of maltodextrin (Cargill MD™ 01960 maltodextrin, DE 11) and 0.0013 g of copper sulfate pentahydrate were heated in a reactor to 98° C. A mixed solution containing 27.3 g of acrylic acid and 43.2 g of a 50% solution of AMPS was added to the reactor over a period of 45 minutes. (The saccharide comprised 75 wt % of the total wt % of saccharide and monomer (acrylic acid+AMPS).) An initiator solution of 13 g of 35% hydrogen peroxide solution in 78 g of deionized water was simultaneously added to the reactor over a period of 60 minutes. The reaction product was held at 98° C. for an additional hour. The polymer was then neutralized by adding 27 g of a 50% solution of NaOH to a pH of about 7. The final product was a clear yellow solution. This sample remained a clear solution with no sign of precipitation even after 6 months.

### Example 5

One-Wash Anti-Redeposition Data Using Commercial Sun Liquid Detergent

Testing was conducted in a full scale washing machine using 3 cotton and 3 polyester/cotton swatches. The soil used was 17.5 g rose clay, 17.5 g bandy black clay and 6.9 g oil blend (75:25 vegetable/mineral). The test was conducted for 3 cycles using 100 g powder detergent per wash load. The polymers were dosed in at 1.0 weight % of the detergent. The wash conditions used a temperature of 33.9° C. (93° F.), 150 ppm hardness and a 10 minute wash cycle.

L (luminance) a (color component) b (color component) values before the first cycle and after the third cycle were measured as L₁, a₁, b₁ and L₂, a₂, b₂, respectively, using a spectrophotometer. Delta whiteness index is calculated using the L, a, b values above. Lower Delta WI (whiteness index) numbers are indicative of better performance.

TABLE 2

| | | Delta WICIE (Whiteness Index) | | | | |
|---|---|---|---|---|---|---|
| | | Cotton | | | | |
| | | Plain | Poly/cotton | Polyester | Cotton | Nylon |
| Sample | Description | weave | Plain weave | Double knit | Interlock | woven |
| Control | No polymer | 6.61 | 5.12 | 11.31 | 12.89 | 3.47 |
| Alcosperse | Na | 4.05 | 3.53 | 5.71 | 8.31 | 1.62 |
| 602N | polyacrylate | | | | | |
| Example 1 | AMPS-AA | 4.45 | 4.05 | 7.30 | 10.31 | 2.62 |
| | mixed feed | | | | | |

### The above data indicates that the polymer of Example 1 performs much better than the Control, and performed nearly as well as the sodium polyacrylate, which is the industry standard for this application.

### Example 6

Sulfonated Copolymer Using 100% Sulfonated Monomers

90 g of water and 65 g of maltodextrin (Cargill MD™ 01960 maltodextrin, DE 11) and 0.00075 g of ferrous ammonium sulfate hexahydrate (FAS) were heated in a reactor to 98° C. A solution containing 100 g of sodium styrene sulfonate dissolved in 500 g of water was added over 150 minutes. An initiator solution comprising 3.6 g of 35% hydrogen peroxide solution in 30 grams of deionized water was simultaneously added to the reactor over a period of 165 minutes. The reaction product was held at 98° C. for an additional hour. The final product was a clear water white solution. The number average molecular weight of this polymer was 4,202. This sample has been a clear solution and shows no sign of precipitation even after 4 months.

### Example 7

Sulfonated Copolymer Grafted on to Small Molecule Natural Alcohol

80 g of water, 15 g of glycerol and 0.0012 g of ferrous ammonium sulfate hexahydrate (FAS) were heated in a reactor to 98° C. A mixed solution containing 16.3 g of acrylic acid and 25.9 g of a 50% solution of sodium 2-acrylamido-2-methyl propane sulfonate (AMPS) was added to the reactor over a period of 45 minutes. An initiator solution comprising 13 g of 35% hydrogen peroxide solution in 30 g of deionized water was simultaneously added to the reactor over a period of 60 minutes. The reaction product was held at 98° C. for an additional hour. The reaction product was cooled and neutralized with 6 g of a 50% NaOH solution.

### Example 8

Sulfonated Copolymer Using a Mixture of Carboxylated Monomers Grafted on to a Polysaccharide

263 g of water, 31.9 g of maleic anhydride, 51.5 g of sodium methallyl sulfonate, 47 g of maltodextrin (Cargill MD™ 01960 maltodextrin, DE 11) and 0.0022 g of copper sulfate pentahydrate were heated in a reactor to 98° C. A solution containing 178 g of acrylic acid dissolved in 142 g of water was added over 150 minutes. An initiator solution comprising 23.8 g of 35% hydrogen peroxide solution in 37 g of deionized water was simultaneously added to the reactor over a period of 180 minutes. The reaction product was held at 98° C. for an additional hour. The reaction product was cooled and neutralized with 90 g of a 50% NaOH solution. The final product was a clear yellowish amber solution.

### Comparative Example 1

Synthesis of Copolymer Using Grafting Recipe Adapted from Example 2 of U.S. Pat. No. 5,227,446—

263.1 g of water, 80 g of maltodextrin (Cargill MD™ 01960, soluble component 90%, DE value of 11 to 14), 63.8 g of maleic anhydride, 0.00075 g (3.5 g of a 0.1% strength) aqueous FAS solution and 94 g of 50% strength aqueous sodium hydroxide solution are heated to a boil in a reactor equipped with stirrer, reflux condenser, thermometer, feed devices, and nitrogen inlet and outlet. The degree of neutralization of maleic acid produced from the maleic anhydride in aqueous solution is 90.2%. Once the reaction mixture has started boiling, a solution of 178.2 g of acrylic acid in 141.9 g of water is added over the course of 5 hours, and a solution of 16.6 g of 50% strength hydrogen peroxide in 44.4 g of water is added at a constant rate over the course of 6 hours at the boil. When the addition of acrylic acid is complete, the degree of neutralization of the maleic acid and acrylic acid units present in the polymer is 31.1%. When the addition of hydrogen peroxide is complete, the reaction mixture is heated at a boil for an additional hour, neutralized to a pH of 7.2 by adding 180 g of 50% strength aqueous sodium hydroxide solution, and cooled.

### Comparative Example 2

Synthesis of Copolymer Using Grafting Recipe Adapted from Example 25 of U.S. Pat. No. 5,227,446—

290 g of maltodextrin having a DE value of from 11 to 14, 470 g of water, 4.2 ml of a 0.1% strength aqueous solution of FAS, 101.38 g of maleic anhydride and 74.52 g of sodium hydroxide are introduced into a reactor and heated to boil. The degree of neutralization of the resultant maleic acid is 90%. Immediately after boiling commences, a mixture of 120 g of acrylic acid and 114.4 g of a 58% strength aqueous solution of the sodium salt of acrylamido methyl propane sulfonic acid is added over the course of 5 hours, and 80 g of 30% hydrogen peroxide and a solution of 24 g of sodium persulfate in 72 g of water are added over the course of 6 hours, in each case at a constant rate and the mixture is polymerized at the boiling point. After the addition of initiator is complete, the reaction mixture is heated at boil for a further 1 hour. The degree of neutralization of the acid groups is 53.5%. After the polymerization is complete, the reaction mixture is neutralized by adding 155 g of 50% strength aqueous sodium hydroxide solution.

### Example 9

Calcium Ortho-Phosphate Inhibition

The polymers in Example 2 and Comparative Example 1 were compared in this test. Phosphate inhibition data is based upon using 20 ppm orthophosphate and 150 ppm polymer in the aqueous treatment system.

Phosphate Inhibition Test Protocol

Solution “A”

Using sodium hydrogen phosphate and sodium tetraborate decahydrate, Solution A was prepared containing 20 mg/L of phosphate, and 98 mg/L of borate at a pH of from 8.0-9.5.

Solution “B”

Using calcium chloride dihydrate and ferrous ammonium sulfate, Solution B was prepared containing 400 mg/L of calcium and 4 mg/L of iron at a pH of from 3.5-7.0.

Anti-Scalant Preparation

The total solids or activity for anti-scalant(s) to be evaluated was determined as follows. The weight of anti-scalant necessary to provide a 1.000 g/L (1000 mg/L) solids/active solution was determined using the following formula:

(% solids or activity)/100%=“X”

wherein “X”=decimal solids or decimal activity. (1.000 g/L)/“X”=g/L anti-scalant required to yield a 1000 mg/L anti-scalant solution.

Sample Preparation

Fifty (50) ml of Solution “B” was dispensed into a 125 ml Erlenmeyer flask using a Brinkman dispensette. Using a graduated piper, the correct amount of anti-scalant polymer solution was added to give the desired treatment level (i.e., 1 ml of 1000 mg/L anti-scalant solution=10 mg/L in samples). Fifty (50) ml of Solution “A” was dispensed into the 125 ml Erlenmeyer flask. At least three blanks (samples containing no anti-scalant treatment) were prepared by dispensing 50 ml of Solution “B” and 50 ml of Solution “A” into a 125-ml Erlenmeyer flask. The flasks were then stoppered and placed in a water bath set at 70° C., +/−5° C., for 16 to 24 hours.

Sample Evaluation

All of the flasks were removed from the water bath and allowed to cool to touch. A vacuum apparatus was assembled using a 250-ml side-arm Edenmeyer flask, vacuum pump, moisture trap, and Gelman filter holder. The samples were filtered using 0.2-micron filter paper. The filtrate from the 250-ml side-arm Erlenmeyer flask was transferred into an unused 100-ml specimen cup. The samples were evaluated for phosphate inhibition using a HACH DR/3000 Spectrophotometer, following the procedure set forth in the operator's manual.

Calculation of Percent Inhibition for All Samples

The percent inhibition for each treatment level is determined by using the following calculation—

% Phosphate inhibition=(S/T)*100

wherein S=mg/L Phosphate for Sample and T=mg/L Total Phosphate added.

TABLE 3
Percent Phosphate Inhibition

| | % Ca phosphate |
|---|---|
| Polymer | inhibition |
| Comparative | 8 |
| Example 1 | |
| Example 2 | 92 |
| Aquatreat 545 | 98 |

The data indicates that polymers of this invention are superior to those of U.S. Pat. No. 5,227,446 in minimizing scale, especially ortho phosphate scale.

### Example 10

The polymers of Example 2 and Comparative Example 1 were tested in the following autodish formulation below for filming and spotting in an automatic dishwasher using ASTM D3556. The formulation used was—

| Ingredient | wt % |
|---|---|
| Sodium tripolyphosphate | 25.0 |
| Sodium carbonate | 25.0 |
| Non ionic surfactant | 1.0 |
| Polymer | 4.0 |
| Sodium sulfate | 45.0 |

The test used a mixture of glasses and plastic tumblers. The soil was 80% margarine and 20% dry milk, which was blended and then smeared on to the surface of the glasses. Soil loading was 40 grams per load. Detergent loading was 40 grams per wash. Water hardness was 350 ppm with a Ca to Mg ratio of 2:1. The test used 4% active polymers of Example 1 and Comparative Example 1. Filming and spotting were visually rated on a scale of 1 to 5, with 1 being the worst and 5 being the best. The visual results of the testing after a total of 3 wash cycles are listed in Table 4.

TABLE 4
Visual results of the autodish tests

| Polymer | Filming | Spotting |
|---|---|---|
| Comparative | 2 | 3 |
| Example 1 | | |
| Example 2 | 3.5 | 4 |
| Control (no | 1 | 1 |
| polymer) | | |

### Example 11

The polymers of Example 2 and Comparative Example 2 were tested for calcium phosphate inhibition according to the inhibition test detailed in Example 9.

TABLE 4
Calcium phosphate inhibition results

| | Level of polymer | % Ca phosphate |
|---|---|---|
| Polymer | (ppm) | inhibition |
| Comparative | 50 | 2 |
| Example 2 | | |
| Example 2 | 50 | 98 |

The data above indicates that the sulfonated polymers of this invention are far superior to the dicarboxylic-containing sulfonated polymer of the '446 patent.

### Example 12

One-cycle soil anti-redeposition test using the test procedure of Example 5 under the following conditions

One wash/dry cycle

92 g Sun liquid detergent

0.5% starch or polymer, where specified

17.5 g rose clay, 17.5 g black charm clay

6.9 g oil blend (50:50 vegetable/mineral)

150 ppm H₂O, 93° F., 10 minute wash

3—cotton 419W swatches

3—poly/cotton swatches

3—polyester double knit swatches

3—cotton interlock swatches

3—Woven nylon swatches

TABLE 5
Anti-redeposition

| | Delta WICIE (Whiteness Index) | | | | |
|---|---|---|---|---|---|
| | Cotton | | | | |
| | Plain | Poly/cotton | Polyester | Cotton | Nylon |
| Sample | weave | Plain weave | Double knit | Interlock | woven |
| Control (no | 4.41 | 6.98 | 13.17 | 19.93 | 3.32 |
| polymer) | | | | | |
| Alcosperse | 4.34 | 4.05 | 5.57 | 12.46 | 2.37 |
| 602N | | | | | |
| Example 3 | 2.44 | 2.24 | 2.28 | 10.09 | 0.53 |
| Example 4 | 2.15 | 2.80 | 2.67 | 9.30 | 0.63 |

### The data indicates that polymers according to the present invention perform better than standard polyacrylate (ALCOSPERSE 602N).

### Examples 13 to 15

### Granular Powder Laundry Detergent Formulations

TABLE 6
Powdered Detergent Formulations

| | Example 13 | Example 14 | Example 15 |
|---|---|---|---|
| Ingredient | (wt %) | (wt %) | (wt %) |
| Anionic surfactant | 22 | 20 | 10.6 |
| Non-ionic surfactant | 1.5 | 1.1 | 9.4 |
| Cationic surfactant | — | 0.7 | — |
| Zeolite | 28 | — | 24 |
| Phosphate | — | 25 | — |
| Silicate | | | 8.5 |
| Sodium | 27 | 14 | 9 |
| carbonate/bicarbonate | | | |
| Sulfate | 5.4 | 15 | 11 |
| Sodium silicate | 0.6 | 10 | — |
| Polyamine | 4.3 | 1.9 | 5 |
| Brighteners | 0.2 | 0.2 | — |
| Sodium perborate | | 1 | |
| Sodium percarbonate | 1 | — | — |
| Sodium hypochlorite | | | 1 |
| Suds suppressor | 0.5 | 0.5 | — |
| Bleach catalyst | 0.5 | — | |
| Polymer of Example 1 | 1 | | |
| Polymer of Example 3 | | 5 | |
| Polymer of Example 6 | | | 2 |
| Water and others | Balance | Balance | Balance |

### Example 16

### Hard Surface Cleaning Formulations

| | |
|---|---|
| Ingredient | wt % |

Acid Cleaner

| | |
|---|---|
| Citric acid (50% solution) | 12.0 |
| Phosphoric acid | 1.0 |
| C₁₂–C₁₅ linear alcohol ethoxylate with 3 moles of EO | 5.0 |
| Alkyl benzene sulfonic acid | 3.0 |
| Polymer of Example 5 | 1.0 |
| Water | 78.0 |

Alkaline Cleaner

| | |
|---|---|
| Water | 89.0 |
| Sodium tripolyphosphate | 2.0 |
| Sodium silicate | 1.9 |
| NaOH (50%) | 0.1 |
| Dipropylene glycol monomethyl ether | 5.0 |
| Octyl polyethoxyethanol, 12–13 moles EO | 1.0 |
| Polymer of Example 3 | 1.0 |

### Example 17

### Automatic Dishwash Powder Formulation

| Ingredients | wt % |
|---|---|
| Sodium tripolyphosphate | 25.0 |
| Sodium carbonate | 25.0 |
| C12–15 linear alcohol ethoxylate with 7 moles of EO | 3.0 |
| Polymer of Example 2 | 4.0 |
| Sodium sulfate | 43.0 |

### Example 18

### Automatic Phosphate-Free Dishwash Powder Formulation

| Ingredients | wt % |
|---|---|
| Sodium citrate | 30 |
| Polymer of Example 1 | 10 |
| Sodium disilicate | 10 |
| Perborate monohydrate | 6 |
| Tetra-acetyl ethylene diamine | 2 |
| Enzymes | 2 |
| Sodium carbonate | 30 |

### Example 19

### Handwash Fabric Detergent

| Ingredients | wt % |
|---|---|
| Linear alkyl benzene sulfonate | 15–30 |
| Nonionic surfactant | 0–3 |
| Na tripolyphosphate (STPP) | 3–20 |
| Na silicate | 5–10 |
| Na sulfate | 20–50 |
| Bentonite clay/calcite | 0–15 |
| Polymer of Example 3 | 1–10 |
| Water | Balance |

### Example 20

### Bar/Paste for Laundering

| Ingredients | wt % |
|---|---|
| Linear alkylbenzene sulfonate | 15–30 |
| Na silicate | 2–5 |
| STPP | 2–10 |
| Polymer of Example 1 | 2–10 |
| Na carbonate | 5–10 |
| Calcite | 0–20 |
| Urea | 0–2 |
| Glycerol | 0–2 |
| Kaolin | 0–15 |
| Na sulfate | 5–20 |
| Perfume, FWA, enzymes, water | Balance |

### Example 21

### Liquid Detergent Formulation

| Ingredients | wt % |
|---|---|
| Linear alkyl benzene sulfonate | 10 |
| Alkyl sulfate | 4 |
| Alcohol (C₁₂–C₁₅) ethoxylate | 12 |
| Fatty acid | 10 |
| Oleic acid | 4 |
| Citric acid | 1 |
| NaOH | 3.4 |
| Propanediol | 1.5 |
| Ethanol | 5 |
| Polymer of Example 5 | 1 |
| Ethanol oxidase | 5 u/ml |
| Water, perfume, minors | up to 100 |

### Example 22

### Water Treatment Compositions

Once prepared, water-soluble polymers are incorporated into a water treatment composition comprising the sulfonated graft copolymer and other water treatment chemicals. Other water treatment chemicals include corrosion inhibitors such as orthophosphates, zinc compounds and tolyl triazole. The level of inventive polymer utilized in water treatment compositions is determined by the treatment level desired for the particular aqueous system treated. Water soluble polymers generally comprise from 10 to 25 percent by weight of the water treatment composition. Conventional water treatment compositions are known to those skilled in the art, and exemplary water treatment compositions are set forth in the four formulations below. These compositions containing the polymer of the present invention have application in, for example, the oil field.

| Formulation 1 | Formulation 2 |
|---|---|
| 11.3% of Polymer of Ex. 1 | 11.3% Polymer of Ex. 4 |
| 47.7% Water | 59.6% Water |
| 4.2% HEDP | 4.2% HEDP |
| 10.3% NaOH | 18.4% TKPP |
| 24.5% Sodium Molybdate | 7.2% NaOH |
| 2.0% Tolyl triazole | 2.0% Tolyl triazole |
| pH 13.0 | pH 12.64 |
| Formulation 3 | Formulation 4 |
| 22.6% of Polymer of Ex. 3 | 11.3% Polymer of Ex. 1 |
| 51.1% Water | 59.0% Water |
| 8.3% HEDP | 4.2% HEDP |
| 14.0% NaOH | 19.3% NaOH |
| 4.0% Tolyl triazole | 2.0% Tolyl triazole |
| pH 12.5 | 4.2% ZnCl₂ |
| | pH 13.2 |

where HEDP is 1-hydroxyethylidene-1,1 diphosphonic acid and TKPP is tri-potassium polyphosphate.

### Example 22

The polymers of Example 4 and a sulfonated synthetic polymer Aquatreat AR 545 (commercially available from Alco Chemical, Chattanooga, Tennessee) were tested for calcium phosphate inhibition according to the inhibition test detailed in Example 9.

TABLE 7
Calcium phosphate inhibition results

| | Level of polymer | % Ca phosphate |
|---|---|---|
| Polymer | (ppm) | inhibition |
| Aquatreat | 50 | 98 |
| AR 545 | | |
| Example 4 | 50 | 98 |

### The data indicate that the Example 4 polymer according to the present invention and having a high amount of saccharide (75 wt % of the total polymer weight) performs similar to a commercial wholly synthetic polymer.

Although the present invention has been described and illustrated in detail, it is to be understood that the same is by way of illustration and example only, and is not to be taken as a limitation. The spirit and scope of the present invention are to be limited only by the terms of any claims presented hereafter.

We claim:

1. Sulfonated graft copolymer obtained by radical graft copolymerization of one or more synthetic monomers in the presence of hydroxyl-containing naturally derived materials that are (a) monosaccharides or disaccharides or (b) oligosaccharides, polysaccharides or small natural molecules comprising:
0.1 to 100 wt %, based on total weight of the synthetic monomers, of at least one monoethylenically unsaturated monomer having a sulfonic acid group, monoethylenically unsaturated sulfuric acid ester or salt thereof,
wherein, when the hydroxyl-containing naturally derived materials are monosaccharides or disaccharides, the hydroxyl-containing naturally derived materials are present in an amount of at least 60% by weight based on total weight of the copolymer, and
wherein, when the hydroxyl-containing naturally derived materials are oligosaccharides, polysaccharides or small natural molecules, the hydroxyl-containing naturally derived materials are present in an amount of at least about 5% by weight based on total weight of the copolymer.

2. Sulfonated graft copolymer according to claim 1, wherein the one or more synthetic monomers and hydroxyl-containing naturally derived materials are present in a weight ratio of 50:50 to 10:90, respectively.

3. Sulfonated graft copolymer according to claim 1, wherein the one or more synthetic monomers and hydroxyl-containing naturally derived materials are present in a weight ratio of 60:40 to 95:5, respectively.

4. Sulfonated graft copolymer according to claim 1 further comprising 5 to 95 wt %, based on total weight of the one or more synthetic monomers, of at least one monoethylenically unsaturated C₃-C₁₀ carboxylic acid, or salt thereof.

5. Sulfonated graft copolymer according to claim 1 further comprising 0.1 to 50 wt %, based on total weight of the one or more synthetic monomers, of at least one ethylenically unsaturated C₄-C₁₀ dicarboxylic acid, or salt thereof.

6. Sulfonated graft copolymer according to claim 1 wherein the one or more synthetic monomers and hydroxyl-containing naturally derived materials are present in a weight ratio of 50:50 to 10:90, respectively.

7. Sulfonated graft copolymer according to claim 1 wherein the synthetic monomers further comprise one or more monomers having a nonionic, hydrophobic and/or carboxylic acid group, wherein the one or more monomers are incorporated into the copolymer in an amount of about 10 wt % or less based on total weight of the graft copolymer.

8. Sulfonated graft copolymer according to claim 1 wherein the hydroxyl-containing naturally derived material is water soluble.

9. Sulfonated graft copolymer according to claim 1 wherein the sulfonic acid monomer is selected from the group consisting of 2-acrylamido-2-methyl propane sulfonic acid, vinyl sulfonic acid, sodium (meth)allyl sulfonate, sulfonated styrene, (meth)allyloxybenzene sulfonic acid, sodium 1-allyloxy 2 hydroxy propyl sulfonate and combinations thereof.

10. Sulfonated graft copolymer according to claim 9 wherein the sulfonic acid monomer is 2-acrylamido-2-methyl propane sulfonic acid, or sodium (meth)allyl sulfonate.

11. Sulfonated graft copolymer according to claim 10 wherein the sulfonic acid monomer is 2-acrylamido-2-methyl propane sulfonic acid.

12. Sulfonated graft copolymer according to claim 1 wherein the weight percent of the natural component in the graft copolymer is about 20 wt % or greater.

13. Sulfonated graft copolymer according to claim 1 where the polysaccharide is a maltodextrin.

14. Cleaning composition comprising the sulfonated graft copolymer according to claim 1, wherein the cleaning composition further comprises one or more adjuvants.

15. Cleaning composition comprising the sulfonated graft copolymer according to claim 1, wherein the copolymer is present in the cleaning composition in an amount of from about 0.01 to about 10 weight %.

16. Cleaning composition comprising the sulfonated graft copolymer according to claim 14, wherein the cleaning composition is a detergent composition.

17. Cleaning composition comprising the sulfonated graft copolymer according to claim 16, wherein the composition is a powdered detergent composition.

18. Cleaning composition comprising the sulfonated graft copolymer according to claim 16, wherein the composition is an autodish composition.

19. Cleaning composition comprising the sulfonated graft copolymer according to claim 16, wherein the composition is a zero phosphate detergent composition.

20. Method of reducing spotting and/or filming in the rinse cycle of an automatic dishwasher comprising adding to the rinse cycle a rinse aid composition comprising the sulfonated graft copolymer according to claim 1.

21. Method of improving sequestration, threshold inhibition and soil removal in a cleaning composition comprising adding the sulfonated graft copolymer according to claim 1 to the cleaning composition.

22. Water treatment system comprising the sulfonated graft copolymer according to claim 1, wherein the graft copolymer is present in the system in an amount of at least about 0.5 mg/L.

23. Method of dispersing and/or minimizing scale in a water treatment or oilfield system comprising adding the sulfonated graft copolymer according to claim 1 to the water treatment or oilfield system.

24. Method of dispersing pigments and/or minerals in a solution comprising adding the sulfonated graft copolymer according to claim 1 to a dispersant composition.

25. Dispersant composition according to claim 23 where the minerals dispersed are titanium dioxide, kaolin clays, modified kaolin clays, calcium carbonates and synthetic calcium carbonates, iron oxides, carbon black, talc, mica, silica, silicates, and aluminum oxide.

26. Method of dispersing soils and dirt in cleaning and water treatment applications comprising adding a dispersant composition comprising the sulfonated graft copolymer according to claim 1 to cleaning system or water treatment system.

27. Dispersant composition comprising the sulfonated graft copolymer according to claim 1, wherein the dispersant composition is added to paints, coatings, plastics, rubbers, filtration products, cosmetics, cement and concrete and/or food and/or paper coatings.

28. Fiberglass binder comprising the sulfonated graft copolymer according to claim 1, wherein the graft copolymer is present in the system from about 0.1 to 50 weight percent of the binder.

29. Method of reducing scale comprising adding the sulfonated graft copolymer according to claim 1 to an oilfield treatment composition, wherein the oilfield treatment composition is used in cementing and drilling mud applications.
